(19) United States
(12) Patent Application Publication
(10) Pub. No.: US 2004/0147677 A1
(43) Pub. Date: Jul. 29, 2004

(54) Thermoplastic vulcanizates

(76) Inventors: Jonas Angus, Harvard, MA (US); Paul Brunelle, Dracut, MA (US)

Correspondence Address: BANNER & WITCOFF, LTD., 28 STATE STREET, 28th FLOOR, BOSTON, MA, 02109-9601, US

(21) Appl. No.: 10/729,419

(22) Filed: Dec. 5, 2003

Related U.S. Application Data
(63) Continuation of application No. PCT/US02/18285, filed on Jun. 10, 2002.
(60) Provisional application No. 60/296,997, filed on Jun. 8, 2001.

(51) Int. Cl. C08F 8/00

(52) U.S. Cl. 525/194

(57) ABSTRACT

Thermoplastic vulcanizates, comprising blends of olefin rubber having a high Mooney Viscosity and thermoplastic olefin resin in which the rubber is completely cured by a phenolic curative, exhibit superior physical properties over other products.

### PRIORITY CLAIM

This application claims priority from commonly owned U.S. Provisional Application Serial No. 60/296,997, filed 8 Jun. 2001, the disclosure of which is hereby incorporated herein by reference.

### FIELD OF THE INVENTION

This application relates to thermoplastic elastomeric (TPE) compositions comprising blends of polyolefin resin and cured olefin rubber. Such materials are often referred to as “thermoplastic vulcanizates” (TPV) and/or “elastoplastic”compositions.

### BACKGROUND OF THE INVENTION

Thermoplastic vulcanizates comprising a cured olefin rubber and polyolefin resin are disclosed in U.S. Pat. No. 4,130,535, the disclosure of which is hereby incorporated herein by reference. These compositions are economically attractive because they may be extended with extender oil and carbon black which additives improve properties including processability and oil resistance while lowering the cost. Thermoplastic elastomeric compositions in which the rubber component has been fully cured using a phenolic curative are taught in U.S. Pat. No. 4,311,628, the disclosure of which is hereby incorporated herein by reference. The present invention represents an improvement of these two patents.

Other patents related to this invention include the following—U.S. Pat. No. 4,036,816, U.S. Pat. No. 4,120,847; U.S. Pat. No. 4,594,390; U.S. Pat. No. 5,073,597; U.S. Pat. No. 5,457,159; U.S. Pat. No. 5,750,625; and U.S. Pat. No. 5,952,425. The disclosures of these patents are hereby incorporated herein by reference.

Thermoplastics are compositions that can be molded or otherwise shaped and reprocessed at temperatures above their melting or softening point. Thermoplastic elastomers are materials that exhibit both thermoplastic and elastomeric properties, i.e., the materials process as thermoplastics but have physical properties like elastomers. Shaped articles may be formed from thermoplastic elastomers by extrusion, blow molding, injection molding or compression molding without the time-consuming cure step required with conventional vulcanizates. Elimination of the time required to effect vulcanization provides significant manufacturing advantages. Further, thermoplastic elastomers can be reprocessed without the need for reclaiming and, in addition, many thermoplastics can be thermally welded.

Automotive weatherseals are undergoing materials and processing shifts from thermoset elastomer compounds like ethylene-propylene-diene monomer (EPDM)-based products to EPDM/PP-based Thermoplastic Vulcanizates (TPVs). EPDM thermoset compounds traditionally are used in weatherseal applications. Going forward, trends indicate that TPVs are gaining momentum, are being applied successfully in building & construction weatherseal applications, and now, in the automotive industry as well. Historically, the evolution of automotive weatherseals materials has been:

Flocked Cloth→Latex→SBR→EPDM→TPV

The key reasons for the latest TPV trends are:

Lower part fabrication costs,

100% recyclability in areas where conventional materials have displayed shortfalls,

Design flexibility (possibility to combine with other thermoplastic materials and elimination of metal inserts),

Weight reduction,

Aesthetics (going beyond “Model T” black and diversifying TPVs by adding color to the seals).

The mechanical properties, benefits, efficiencies and processing solutions of TPVs are discussed below, focusing on weatherseals for automotive, building and construction use. In these segments, applications are diverse and range from: glass run channels, hood-to-cowl seals, hood-to-radiator seals, belt line seals, roof gutter seals and glass encapsulation applications.

Presently, most static and semi-dynamic seals are strong candidates for EPDM-based TPVs. The benefits of switching to TPVs will be explored, including cost savings, processing ease, fulfilling “green” recycling goals, offering design flexibility, weight reduction and meeting aesthetic goals.

Initially, we discuss improvements made with TPVs which address some of the present constraints found in the automotive sealing systems segment. Then, the advantages that this thermoplastic material offers will be detailed. And finally, a convincing business case history presenting bottom line cost savings of the TPV systems versus more traditional systems will be presented.

In the ongoing search to replace some thermoset rubber materials in weatherseal applications, TPVs are being used in a growing number of industries and applications (including automotive under-the-hood rubber components). Yet, while TPVs have successfully displaced PVC, EPDM and polychloroprene (Neoprene) thermoset rubbers, the physical properties of the current crop of commercially available TPVs have not yet achieved their full potential in the marketplace.

As compared to low hardness (Shore 55A to 75A) compounds, EPDM thermoset compounds typically have exhibited higher tensile and tear strengths than TPV compounds. Recent advancements in TPV technology have made it possible to show improvements in the mechanical strength in the Shore 40A to 50D hardness ranges.

Table 1 outlines improvements in tensile strength, showing gains of at least 10% in low hardness grades. In addition, significant improvements in tear strength are shown (approximately 30%). Tear strength improvements represent a major advance for TPV weatherseals. Higher tear strength helps the handling phase of the total fabrication process, and in overall seal durability.

TABLE 1

| | | | Shore 55A | | Shore 64A | | Shore 73A | | Shore 80A | | Shore 87A | |
|---|---|---|---|---|---|---|---|---|---|---|---|---|
| | Test | | | NexPrene | | NexPrene | | NexPrene | | NexPrene | | NexPrene |
| Property | Method (ASTM) | Units | TPV-A | 1055A | TPV-A | 1064A | TPV-A | 1075A | TPV-A | 1080A | TPV-A | 1087A |
| Specific | D-792 | | 0.97 | 0.97 | 0.97 | 0.97 | 0.97 | 0.97 | 0.97 | 0.97 | 0.96 | 0.96 |
| Gravity | | | | | | | | | | | | |
| Tensile | D-412 | MPa | 4.4 | 6.6 | 6.9 | 7.6 | 8.5 | 10 | 11 | 12.4 | 15.9 | 16.9 |
| Strength | | | | | | | | | | | | |
| Tear | D-624 | KN/m | 19 | 31 | 25 | 35 | 28 | 47 | 34 | 57 | 49 | 69 |
| Strength | | | | | | | | | | | | |
| (“X Flow”) | | | | | | | | | | | | |
| Comp. Set | D-395, | % | 27 | 27 | 31 | 32 | 35 | 35 | 41 | 41 | 45 | 45 |
| (22 Hrs @ | (Method B) | | | | | | | | | | | |
| 70° C.) | | | | | | | | | | | | |

Note:
TPV-A is a commercially available fully vulcanized TPV, the properties of which are shown for comparative puroses only.

### SUMMARY OF THE INVENTION

There have now been discovered compositions comprising blends of polyolefin resin and monoolefin copolymer rubber characterized by the rubber being fully cured with a phenolic curative but the blends nevertheless being processable as thermoplastics and having improved physical properties as compared to uncured or partially cured blends heretofore known. Such blends in which the rubber is cured are herein referred to as vulcanizates. It was found that if the proportion of resin in the blend is above certain critical limits, which vary somewhat with the particular resin, rubber and compounding ingredients selected, the fully cured compositions are still thermoplastic.

The EPDM rubber is cured in the compositions of the invention. By “cured” we mean that at least 95%, preferably at least 97%, more preferably at least 99%, and most preferably at or about the theoretical level of 100% of the rubber has been cured or cross-linked by the phenolic curative. The degree of curing may readily be determined using methods well known to those having ordinary skill in this art.

The compositions of the present invention are compositions comprising blends of (a) thermoplastic crystalline polyolefin resin, in an amount sufficient to impart thermoplasticity to the composition, and (b) cured EPDM rubber, in an amount sufficient to impart rubberlike elasticity to the composition, in which the rubber is cured with phenolic curative comprising phenolic curing resin and cure activator.

Surprisingly it has been discovered that EPDM rubber produced by a slurry method (see, for example U.S. Pat. No. 6,384,162—hereby incorporated herein by reference) and having a relatively high Mooney Viscosity provides superior physical properties to the finished TPV composition.

A Mooney viscometer is used to determine an arbitrary value called a “Mooney Unit” or MU based upon measurements made by rotating a special serrated rotor while embedded in a rubber sample within a sealed, pressurized, serrated, temperature controlled cavity. Mooney Unit values will differ based upon different temperatures used for conducting the measurement. For purposes of the present invention, the Mooney Viscosity of the raw polymer should be measured at 150° C.−ML (1+8) in accordance with ISO 289 and/or ASTM D1646. Mooney Units thus measured should be at least 100, preferably at least 150, more preferably at least 200, and most preferably at least 300, for purposes of forming TPVs with advantageous properties as described in greater detail below. Mooney Viscosities of the oil-filled polymers (up to 50%) are generally about 10% of the value of the raw polymer Mooney Viscosity.

The relative proportions of polyolefin resin and EPDM rubber are not subject to absolute delineation because the limits vary due to a number of factors including type, molecular weight, or molecular weight distribution of the polyolefin resin or EPDM rubber and are dependent upon the absence or presence of other ingredients in the composition. For example, inert fillers such as carbon black or silica tend to reduce the operative range, whereas, extender oil and plasticizers tend to increase the range of operative proportions.

Generally, the compositions comprise blends of about 15-75 parts by weight of thermoplastic crystalline polyolefin resin and about 85-25 parts by weight of EPDM rubber per 100 total parts by weight of polyolefin resin and rubber. Preferred compositions comprise blends of about 25-75 parts by weight of thermoplastic crystalline polyolefin resin and about 75-25 parts by weight of EPDM rubber per 100 total parts by weight of polyolefin resin and rubber. More preferred compositions contain polyolefin resin in amounts not exceeding 50 weight percent of the total composition.

Vulcanizable rubbers, although thermoplastic in the unvulcanized state, are normally classified as thermosets because they undergo the irreversible process of thermosetting to an unprocessable state. The products of the instant invention, although processable, are vulcanizates because they can be prepared from blends of rubber and resin which are treated with curatives in amounts and under time and temperature conditions known to give fully cured products from static cures of the rubber in molds and, indeed, the rubber has undergone gelation to the extent characteristic of such state of cure. The thermoset state can be avoided in the compositions of the invention by simultaneously masticating and curing the blends. Thus, the thermoplastic vulcanizates of the invention may be prepared by blending a mixture of olefin copolymer rubber, polyolefin resin, and curatives, then masticating the blend at vulcanization temperature until vulcanization is complete, using conventional masticating equipment, for example, Banbury mixer, Brabender mixer, or certain mixing extruders, such as fully intermeshing, co-rotating twin-screw extruders.

The ingredients except curative are mixed at a temperature sufficient to soften the polyolefin resin or, more commonly, at a temperature above its melting point if the resin is crystalline at ordinary temperatures. After the resin and rubber are intimately mixed, curative is added. Heating and masticating at vulcanization temperatures are generally adequate to complete the vulcanization reaction in a few minutes or less, but if shorter vulcanization times are desired, higher temperatures may be used. A suitable range of vulcanization temperatures is from about the melting temperature of the polyolefin resin (about 120° C. in the case of polyethylene and about 175° C. in the case of polypropylene) to 250° C. or more; typically, the range is from about 150° C. to 225° C. A preferred range of vulcanization temperatures is from about 180° to about 200° C. To obtain thermoplastic vulcanizates, it is important that mixing continues without interruption until vulcanization occurs. If appreciable curing is allowed after mixing has stopped, a thermoset unprocessable vulcanizate maybe obtained.

Moreover, the particular results obtained by the above-described dynamic curing process are a function of the particular rubber curing system selected. The curatives and the curative systems conventionally used to vulcanize olefin rubbers are utilizable for preparing the improved thermoplastics of the invention, but it appears to have been heretofore unrecognized that some curatives, particularly certain peroxides, may degrade polyolefin resins during dynamic curing to the extent that the desired results are not obtained. Similarly, although monoolefin copolymer rubbers commercially available are utilizable for preparing the improved thermoplastics, such rubbers having narrow molecular weight distributions provide thermoplastic vulcanizates with improved tensile properties as compared to olefin copolymer rubbers which form networks less efficiently in the vulcanization process. Polydispersity values (weight average molecular weight divided by number average molecular weight) of less than about 3.5 and, more preferably, less than 3.0 or 2.6 are desirable for the monoolefin copolymer rubber.

Moreover, the presence of at least about 25% by weight of polyolefin resin in the blend is required for the consistent preparation of processable thermoplastic elastomers. It is thus possible to obtain unprocessable dynamically cured vulcanizates even before complete gelation has occurred or to obtain only minor improvements in tensile strength by vulcanization. But it is assumed that no one would want to achieve a useless result, and would not be mislead by the fact that the interaction of the variables that influence the result is imperfectly understood. A few simple experiments within the skill of the art utilizing available rubbers and curative systems will suffice to determine their applicability for the preparation of the improved products of this invention.

Suitable monoolefin copolymer rubber comprises essentially non-crystalline, rubbery copolymer of two or more alpha monoolefins, preferably copolymerized with at least one polyene, usually a diene. However, saturated monoolefin copolymer rubber, commonly called “EPM” rubber, can be used, for example copolymers of ethylene and propylene. Examples of unsaturated monoolefin copolymer rubber, commonly called “EPDM” rubber, which are satisfactory comprise the products from the polymerization of monomers comprising two monoolefins, generally ethylene and propylene, and a lesser quantity of non-conjugated diene. Suitable alpha monoolefins are illustrated by the formula CH₂=CHR in which R is hydrogen or alkyl of 1-12 carbon atoms, examples of which include ethylene, propylene, 1-butene, 1-pentene, 1-hexene, 2-methyl-1-propene, 3-methyl-1-pentene, 4-methyl-1-pentene, 3,3-dimethyl-1-butene, 2,4,4-trimethyl-1-pentene, 5-methyl-1-hexene, 1,4-ethyl-1-hexene and others. Satisfactory non-conjugated dienes include straight chain dienes such as 1,4-hexadiene, cyclic dienes such as cyclooctadiene and bridged cyclic dienes such as ethylidenenorborene.

Specific grades of EPM and EPDM rubbers suitable for the practice of the invention are commercially available, particularly those sold under the Buna®-trademark by Bayer. One preferred EPDM rubber is Buna EPT 5459 (Mooney Viscosity (ML 1+8) of the oil extended (about 50%) polymer is about 38±7 at 150° C.). Similar products from other suppliers may be located in the current edition of the Rubber World Blue Book under Materials and Compounding Ingredients for Rubber. This yearly publication is well known to those having ordinary skill in this art.

The newest members of the NexPrene® TPV family use Buna EPT 8902 (EPDM), a high molecular weight product with unique attributes. The high molecular weight of the EPDM coupled with a very efficient process contributes to the improved properties in tensile and tear strength. Also white clean process oil is used which contributes to the low fogging numbers. High polymer molecular weights and white clean process oil address previous detractions from using TPVs for weatherseals. These advances overcome the problems with older TPVs, addressing their limitations.

Suitable thermoplastic polyolefin resins comprise crystalline, high molecular weight solid products from the polymerization of one or more monoolefins by either high pressure or low-pressure processes. Examples of such resins are the isotactic and syndiotactic monoolefin polymer resins, representative members of which are commercially available. Examples of satisfactory olefins are ethylene, propylene, 1-butene, 1-pentene, 1-hexene, 2-methyl-1-propene, 3-methyl-1-pentene, 4-methyl-1-pentene, 5-methyl-1-hexene and mixtures thereof. Commercially available thermoplastic polyolefin resin, and preferably polyethylene or polypropylene, may be advantageously used in the practice of the invention, with polypropylene being preferred.

Any phenolic curative system that fully cures EPDM rubber is suitable in the practice of the invention. A basic ingredient of such system is a phenolic curing resin made by condensation of halogen substituted phenol, C1-C10 alkyl substituted phenol or unsubstituted phenol with an aldehyde, preferably, formaldehyde, in an alkaline medium or by condensation of bifunctional phenoldialcohols. Dimethylol phenols substituted in the para-position with C5-C10 alkyl groups are preferred. Halogenated alkyl substituted phenol curing resins prepared by halogenation of alkyl substituted phenol curing resin are also especially suitable.

Phenolic curative systems comprising methylol phenolic resins, halogen donor and metal compound are especially recommended, details of which are described in U.S. Pat. No. 3,287,440 and U.S. Pat. No. 3,709,840, the disclosures of which are hereby incorporated herein by reference. Non-halogenated phenol curing resins are used in conjunction with halogen donors, preferably, along with a hydrogen halide scavenger. Ordinarily, halogenated, preferably brominated, phenolic resins containing 2-10 weight percent bromine, do not require halogen donor but are used in conjunction with a hydrogen halide scavenger such as metal oxides such as iron oxide, titanium oxide, magnesium oxide, magnesium silicate, silicon dioxide and preferably zinc oxide, the presence of which promotes the cross-linking function of the phenolic resin.

With rubbers that do not readily cure with phenolic resins, the conjoint use of a halogen donor and zinc oxide is recommended. The preparation of halogenated phenol resins and their use in a curative system with zinc oxide are described in U.S. Pat. Nos. 2,972,600 and 3,093,613, the disclosures of which are hereby incorporated herein by reference. Examples of suitable halogen donors are stannous chloride, ferric chloride, or halogen donating polymers such as chlorinated paraffin, chlorinated polyethylene, chloro-sulfonated polyethylene, and polychlorobutadiene (neoprene rubber).

The term “activator” as used herein means any material that materially increases the cross-linking efficiency of the phenolic curing resin and includes metal oxides and halogen donors either used alone or conjointly. For further details of phenolic curative systems see “Vulcanization and Vulcanizing Agents,”W. Hoffman, Palmerton Publishing Company. Suitable phenolic curing resins and brominated phenolic curing resins are commercially available, for example, such resins may be purchased under the trade names SP-1045, CRJ-352, SP-1055 and SP-1056 from Schenectady Chemicals, Inc. Similar functionally equivalent phenolic curing resins may be obtained from other suppliers. As explained above, sufficient quantities of curatives are used to achieve essentially complete cure of the rubber.

The properties of the thermoplastic vulcanizates of this invention may be modified, either before or after vulcanization, by addition of ingredients that are conventional in the compounding of monoolefin copolymer rubber, polyolefin resin and blends thereof. Examples of such ingredients include carbon black, silica, titanium dioxide, colored pigments, clay, zinc oxide, stearic acid, accelerators, vulcanizing agents, sulfur, stabilizers, antidegradants, processing aids, adhesives, tackifiers, plasticizers, wax, prevulcanization inhibitors, discontinuous fibers such as wood cellulose fibers and extender oils.

The addition of carbon black, extender oil or both, preferably prior to dynamic vulcanization, is particularly recommended. Carbon black improves the tensile strength and extender oil can improve the resistance to oil swell, heat stability, hysteresis, cost and permanent set of the thermoplastic vulcanizate. Aromatic, naphthenic and paraffinic extender oils are satisfactory.

The addition of extender oil can also improve processability. For suitable extender oils, the skilled artisan will usually refer to the Rubber World Blue Book. The quantity of extender oil added depends upon the properties desired, with the upper limit depending upon the compatibility of the particular oil and blend ingredients which limit is exceeded when excessive exuding of extender oil occurs. Typically, 5-300 parts by weight extender oil are added per 100 parts by weight blend of olefin rubber and polyolefin resin. Commonly about 30 to 250 parts by weight of extender oil are added per 100 parts by weight of rubber present in the blend with quantities of about 70 to 200 parts by weight of extender oil per 100 parts by weight of rubber being preferred.

Typical additions of carbon black comprise about 40-250 parts by weight of carbon black per 100 parts by weight of olefin rubber and usually about 20-100 parts by weight carbon black per 100 parts total weight of olefin rubber and extender oil. The amount of carbon black that can be used depends, at least in part, upon the type of black and the amount of extender oil to be used. The amount of extender oil depends, at least in part, upon the type of rubber. High viscosity rubbers are more highly oil extendable.

Thermoplastic elastomeric vulcanizates of the invention are useful for making a variety of articles such as hoses, belts, gaskets, moldings and molded parts. They are particularly useful for making articles by extrusion, blow molding, injection molding and compression molding techniques. They also are useful for modifying thermoplastic resins, in particular, polyolefin resins. The vulcanizates are blended with thermoplastic resins using conventional mixing equipment. The properties of the modified resin depend upon the amount of vulcanizate blended. Generally, the amount of vulcanizate is such that the modified resin contains about 5 to 25 parts by weight of olefin rubber per about 95 to 75 parts total weight of resin.

One exciting area of use for these TPV compounds is in the formation of automotive weatherseals such as glass run channels and belt line seals are designed to provide sealing against noise, damping, dust, water and air. Typically, a low friction surface of the seal is required in areas where the seal comes in contact with the door glass. The main reason for the low friction surface is wear resistance. In U.S. Pat. No. 5,306,537, for TPV shore 75A glass run channel, a Shore 50D thermoplastic powder is utilized as the slip coat material via coextrusion. However, the Shore 50D material does not meet all of the stringent abrasion resistance requirements.

One of the complications in using TPVs for weatherseal applications is the fogging that can occur on clear glass due to the process oil that leaches out of the compound. Additionally, and specific to the automobile marketplace, fogging is an issue for soft-touch interior components like grips, cup holders, handles, bin liner and shift lever seals applications. Consumers and manufacturers both are dissatisfied with seals that contribute to fog on the glass. The TPVs of the present invention resist this oil migration. Latest tests indicate that these new TPVs yield a weight loss as low as 1.2±0.2 milligrams at 100° C. for 16 hours as per the SAE 1756 gravimetric method. The weight loss is roughly half that which traditional general purpose TPVs experience.

One embodiment of the present invention pertains to the discovery that a high-density moisture curable polyethylene—like XL-HDPE NexCoat™ is a cost-effective and viable alternative to the slip coat material previously employed in automotive weatherseals for glass. This technology is based on silane pre-grafted onto the backbone of polyethylene. The pre-grafted resin is then mixed with a catalyst masterbatch just before processing. The compound is then extruded on a convectional thermoplastic extruder. This is a viable alternative to ultra high molecular weight polyethylene, which has exceptional wear resistance but cannot be easily coextruded using thermoplastic processing without sacrificing wear resistance.

Surprisingly, XL-HDPE can be coextruded onto TPVs as a slip coat to provide exceptional results. Abrasion resistance testing based on GM9909P (General Motors) specifications yielded 10,330 cycles per 5 kg, where the minimum requirements are 10,000 cycles per 3 kg load. This also yields a coefficient of friction (COF) of 0.3. Using this optimized process, a product can be manufactured with a COF in the range of 0.1 to 0.3, using a clean technology. In contrast, a Shore 50D TPV yields a COF of 0.6, thus inadequate wear resistance. Another benefit is that the scrap of the coextruded Shore 75A and the XL-HDPE slip coat can be reground and reutilized, addressing recycling issues.

Generally, due to the high content of the pure EPDM in TPV-EPDM/PP products, it is more expensive than traditional materials. The upside to using TPVs is that manufacturers see quantitative savings in the finished product; typically, the cost per part is reduced by 10-30% due to efficient thermoplastic processing, waste reduction and the ability to recycle waste materials. EPDM/PP based TPVs exhibit a two-phase morphology. The PP is the continuous phase component in the morphology, and the highly vulcanized rubber particles (approximately 1 to 2 microns in average particle size) constitute the dispersed phase. Even though the concentration of rubber is much higher than the PP in TPVs, the PP provides ease of processing. Thus, TPVs are ideal for injection molding, blow molding, and extrusion operations.

An all TPV glass run channel and belt line seal is the “best-fit”automotive weatherseal application. It benefits most from tremendous cost savings (up to 30% or more) through the elimination of long cycle times for corner molding and complex traditional flocking processes. In addition to the cost savings, there is also an approximately 22% weight savings by using an all TPV seal. Table 2 shows a cost comparison—this is where the “rubber meets the road”.

TABLE 2
Cost Comparison Chart

| | | Traditional Thermoset |
|---|---|---|
| | All TPV Glass Run | EPDM Compound + |
| Cost | Channel | Flocking |
| Processing | | |
| Rubber Compounding | 0 | 5% |
| Extrusion | 10% | 15% |
| | (co-ex) | (vulcanizing) |
| Flocking | 0% | 6% |
| Cutting | 0% | 4% |
| Corner Molding | 15% | 25% |
| Flash/Scrap | 1% | 5% |
| Total Processing Cost | 26% | 60% |
| Raw Material | | |
| Extrusion Material | 40% | 20% |
| Corner Molding Material | 4% | 2% |
| Flocking Material | | |
| Primer | 0% | 4% |
| Adhesive | 0% | 6% |
| Polyester Fiber | 0% | 8% |
| Total Raw Material Cost | 44% | 40% |
| | 70% | 100% |

The latest generation of EPDM/PP fully vulcanized TPVs are not restricted to “old materials paradigms.” By directly addressing the needs of the marketplace, newly formulated TPV compounds deliver low fogging, higher tear strength, higher tensile strength and more environmentally friendly materials to aid in the goal of creating fully recyclable vehicles. Enhanced aesthetics and colorability, and UV resistance coupled with ease of processing position the latest TPV grades for expansion into other areas beyond secondary weatherseals for the automotive, building and construction markets. In the future, a trend of system integration like combining polycarbonate windows with an integrated TPV seal is a possibility.

Going forward, EPDM-based TPVs are positioned to expand into the 500 KM Ton plus automotive weatherseal EPDM compound market. TPVs offer viable alternatives to markets that strive to overcome the limitations of thermoset rubber, while maintaining their benefits like cost, weight reduction and recyclability.

In summary, the TPVs of the present invention provide greater flexibility to manufacturers than ever before. The greatest challenge to production is cost; the low friction technology benefit of the latest TPV compounds competes with very expensive flocking and coating technologies used in thermoset systems.

### BRIEF DESCRIPTION OF THE DRAWINGS

The foregoing and other features and advantages of the present invention will be apparent from the following detailed description of the preferred embodiment of the invention, and as illustrated in the accompanying drawings. The drawings are not necessarily to scale, emphasis instead being placed upon illustrating the principles of invention.

FIG. 1 illustrates the preferred twin-screw extruder used in the manufacture of the TPVs of the present invention.

FIG. 2 illustrates a typical block-copolymer process configuration using the twin-screw extruder of FIG. 1.

FIG. 3 illustrates a typical TPU process configuration using the twin-screw extruder of FIG. 1.

FIG. 4 illustrates a typical TPO process configuration using the twin-screw extruder of FIG. 1.

FIG. 5 illustrates a typical TPV process configuration using the twin-screw extruder of FIG. 1.

FIG. 6 illustrates the differences between TPE processing and thermoset rubber processing.

FIG. 7 illustrates a preferred TPV process configuration using a twin-screw extruder.

### DETAILED DESCRIPTION OF THE PREFERRED EMBODIMENTS

The present invention will be further illustrated with reference to the following examples which aid in the understanding of the present invention, but which are not to be construed as limitations thereof. All percentages reported herein, unless otherwise specified, are percent by weight. All temperatures are expressed in degrees Celsius.

The TPVs of the present invention may be formulated in a variety of colors—natural, black and vibrant primary colors (red, blue, yellow, etc.). Use applications currently include automotive weatherseals, under the hood products, building and construction products, medical goods and apparel, products that need to meet FDA and NSF requirements, appliances, and electrical and electronic products as well as packaging and consumer goods.

The following Table 3 describes a number of general purpose grades of NexPrene® rubber—each of which is a fully cross-linked EPDM/PP TPV compound designed to replace thermoset elastomers such as polychloroprene (Neoprene), EPDM, as well as Santoprene TPV. NexPrene rubber provides the advantage of low-cost thermoplastic processing as well as performance of vulcanized thermoset rubber suitable for numerous components in the following market segments: Automotive, Appliance (white goods), Business machines, Construction, Consumer products, Electrical & Electronics, Food contact, Fluid delivery, Hardware and Medical devices.

TABLE 3
NexPrene Rubber:
General Purpose Grades

| Typical | | | | | | | | | | | | | |
|---|---|---|---|---|---|---|---|---|---|---|---|---|---|
| Physical Property | ASTM | UNITS | 1040A | 1045A | 1050A | 1055A | 1060A | 1064A | 1070A | 1075A | 1080A | 1084A | 1087A |
| Hardness: Extrusion | D-2240 | A or D | 36A | 41A | 46A | 51A | 56A | 59A | 66A | 71A | 77A | 80A | 84A |
| (5 seconds) | | | | | | | | | | | | | |
| I. Molded (5 seconds) | | | 40A | 45A | 50A | 55A | 60A | 64A | 70A | 75A | 81A | 84A | 87A |
| Specific Gravity | D-792 | | 0.93 | 0.94 | 0.97 | 0.97 | 0.97 | 0.97 | 0.97 | 0.97 | 0.97 | 0.96 | 0.96 |
| Tensile Strength | D-412 | MPa | 5 | 5.2 | 6.3 | 6.5 | 7 | 7.6 | 8.7 | 10 | 12.4 | 14.5 | 16.8 |
| Tensile Modulus @ | D-412 | Mpa | 0.9 | 0.96 | 1.6 | 2.2 | 2.4 | 2.7 | 3.1 | 3.6 | 4.7 | 5.5 | 6.1 |
| 100% | | | | | | | | | | | | | |
| Ultimate Elongation | D-412 | % | 800 | 850 | 400 | 427 | 500 | 540 | 611 | 631 | 649 | 525 | 550 |
| Tear Strength, Die C | D-624 | KN/m | 11.5 | 13 | 17 | 31 | 32 | 34 | 41 | 47 | 57 | 59 | 60 |
| IRM 903 Oil, Vol Swell | D-471 | % | 130 | 125 | 120 | 110 | 110 | 110 | 100 | 90 | 85 | 82 | 80 |
| (125° C./70 hrs) | | | | | | | | | | | | | |
| Compression Set: | D-395 | % | 26 | 26 | 27 | 27 | 28 | 29 | 32 | 35 | 41 | 43 | 45 |
| 22 hr/70° C. | | | | | | | | | | | | | |
| 168 hrs/ | | | | | 28 | 28 | 30 | 35 | 37 | 39 | 42 | 45 | 47 |
| 100° C. | | | | | | | | | | | | | |
| Ozone Resistance | D-1149 | Good | Good | Good | Good | Good | Good | Good | Good | Good | Good | Good | Good |
| 500 hrs/100 pphm | | | | | | | | | | | | | |
| ozone conc. | | | | | | | | | | | | | |

The TPV materials of the present invention are manufactured using a one-step process. In general, a “state of the art” twin-screw extruder is employed. One commercial example is the ZSK fully intermeshing, co-rotating twin-screw extruder, available from the Werner & Pfleiderer Corporation of Ramsey, N.J. See also, U.S. Pat. No. 6,042,260, the disclosure of which is hereby incorporated herein by reference. Use of this type of equipment improves the consistency, the quality of dispersion, and reduces the heat history in the compounding of TPE formulations. This is a discreet type of mixer, where every particle of material sees the same shear stress. The equipment is modular, enabling a process configuration optimized for any desired process task. The process tasks can be broken down into unit operations, and each unit operation can be optimized independently from the other unit operations. Presently the production line consists of the following major equipment:

A twin screw extruder for production

Rubber grinding equipment

Mixing equipment and holding tank

Feeders

Pelletizing system

Vibratory Screen

Drying equipment

Packaging equipment

Cooling Tower

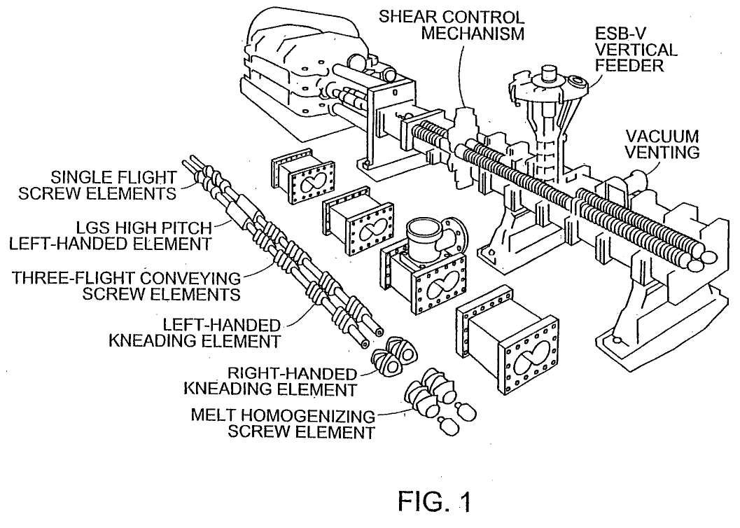

The key elements that result in improved quality of compound mixed on a ZSK fully intermeshing, co-rotating twin screw extruder are: (see, FIG. 1):

Modular construction of the compounding equipment which allows the process configuration to be designed for the specific task at hand

The ability to create high shear stresses to facilitate good dispersion

The ability to provide a homogeneous distribution of all the additives in the matrix

A design that exposes each particle to short and equal stresses

Exact temperature control to regulate the heat history and to keep it at a minimum

Easy cleaning of the extruder to accommodate color and formulation changes

Compounding Various Types of TPEs:

1. Block Co-polymer (Kraton, etc.)

2. TPUs

3. TPOs

4. TPVs

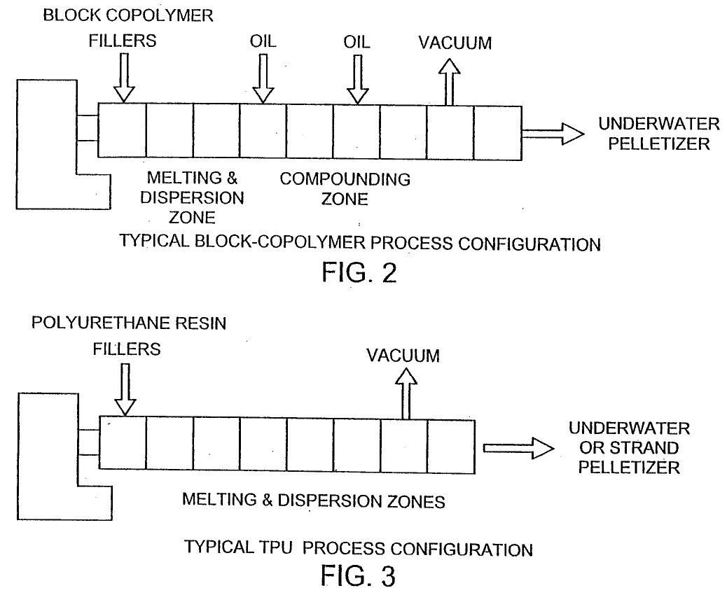

1. Block Co-Polymers (See, FIG. 2):

Typical block co-polymer compounds are filled with various levels of oils, fillers and colorants. The products produced from these compounds have certain rheological and physical property requirements. To meet these requirements, compounding should be performed on an extruder that has the versatility to stage the mixing operations, both dispersive and distributive. The configuration for this process task usually requires a processing length of 28:1 to 40:1 L/D. All of the dry ingredients are fed into the first barrel, either as separate feed streams or as a preblend of the resin and fillers. The melting of the resins and dispersion of the filers take place rapidly in the first 12 to 16 L/D. If low bulk density fillers are used, a side feeder might be required to accomplish the incorporation of the required ratios. Oil can be added tot eh process either in single or multiple feed streams by utilizing liquid injection nozzles. Incorporating the oil with the split-stream method has two benefits; (1) higher percentages can be incorporated, (2) potential surging problems can be eliminated. A vacuum is applied in the next to the last barrel. This facilitates the removal of gases, moisture, etc. This technique enhances pellet appearance and quality. An underwater pelletizer is recommended as the preferred type cutter for these TPEs.

2. Thermoplastic Polyurethanes (See, FIG. 3):

Thermoplastic polyurethanes are typically processed on a 32:1 L/D extruder. Usually, TPUs are filled with trace materials (radio opaque fillers) for medical applications. Both the resin and filler are fed into the 1^{st} barrel. A gentle screw design is used to melt the resin and to achieve the desired amount of distributive and dispersive mixing. The most common problem with this type of TPE is gels. Gels are the by-products of certain polymerization processes. By designing the proper screw configuration, these gels can be eliminated. Normally, a vacuum is applied prior to the last barrel (pressurization zone) to remove gases or moisture from the polymer. Pelletizing is achieved by any of the usual methods, i.e. strand, water ring or underwater.

Today, the twin screw ZSK extruder is also used for continuous polymerization of TPUs. The process eliminates the forming of gels in the feedstocks. It should be noted that achieving the dispersion level and quality is not a problem with a twin screw ZSK type extruder.

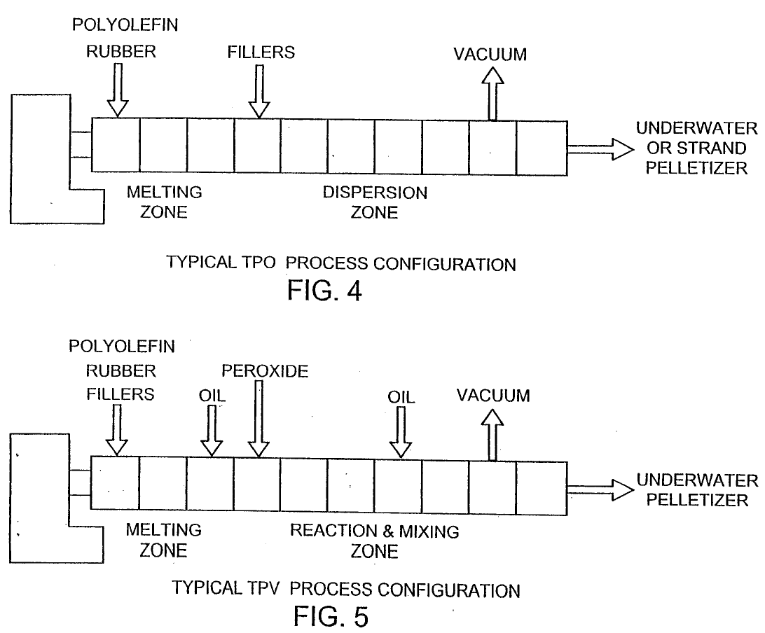

3. Thermoplastic Olefins (See, FIG. 4):

TPO compounds are rubber-modified polyolefins, normally with high levels of fillers and in various colors. The parts made from these compounds have specific physical properties, as well as tactile and aesthetic requirements that can only be met with controlled mixing techniques.

The process configurations for compounding these types of formulations in the twin-screw extruder are slightly longer (36:1 or 40:1 L/D) than is needed for the block co-polymer and TPU formulations discussed previously.

The rubber, as a particulate, and the polyolefin are fed into the first barrel and are melted and masticated into a homogeneous matrix in the first 12 to 16 L/D.

Minor additives, i.e. antioxidants, stabilizers and colorants, if used, are also fed here. It is important to process the two polymers together, essentially unfilled, to generate a uniform polymer matrix for optimal properties. The high volume fillers are added into the process section downstream, usually with a side feeder. These are dispersively mixed into the polymer matrix in the second process segment. The fillers are being added to a high viscosity liquid. This technique enhances the ability to fully disperse the fillers without creating agglomerates, which result in defects in the finished product. The technique also minimizes wear in the equipment and enables higher throughput rates. A vacuum is now applied to facilitate removal of gases and moisture in addition to eliminating voids in the pellets. Pelletizing can be accomplished by using standard techniques, i.e., strand or underwater.

4. Thermoplastic Vulcanizates (See, FIG. 5):

Compounding of TPVs combines come of the techniques discussed for TPOs with reactive processing techniques. All the dry ingredients are fed into the first barrel, including the catalyst system. They are melted and masticated into a homogeneous matrix in the first 12 to 16 L/D. The phenolic cross-linking reactant is usually injected directly over mixing elements to dispersively mix in the reactant very quickly. This technique essentially reduces to zero the mass transfer limitation of the reaction. This results in reaction times that are solely the function of the kinetics of the cross-linking reaction. A short process segment is all that is needed to provide the necessary residence time for the reaction to go to completion (4 to 8 L/D).

Process oils are normally used in these formulations. They can be added downstream of the reaction zone, or can be fed partially upstream in the polymer melting and mastication zone; the balance downstream of the reaction zone. Process performance and product quality are used to determine the appropriate addition sites for the process oil streams.

Vacuum is used to pull off the gaseous by products of the cross-linking reaction, as well as moisture and assures excellent pellet quality. Due to the elastomeric nature of the TPV compounds, hot die face or underwater palletizing systems are preferred.

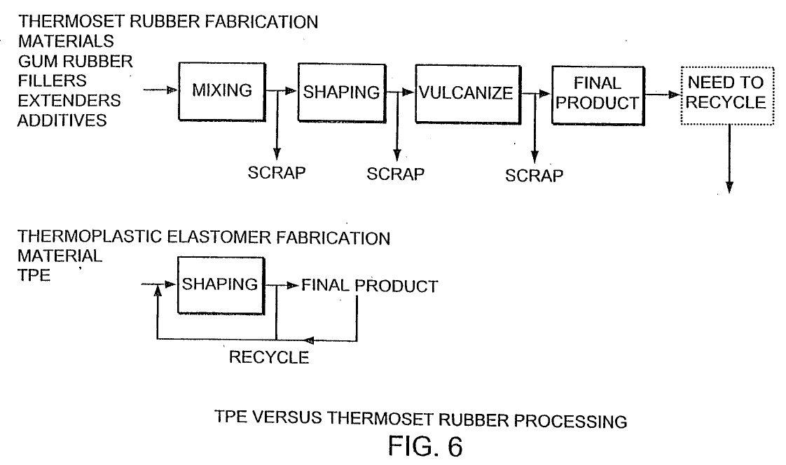

As illustrated in FIG. 6 and as shown below in Table 4, TPE processing has a number of advantages over thermoset rubber processing.

TABLE 4
Advantages of TPE over Thermoset Rubber Processing:

| Variable | TPE | Thermoset Rubber |
|---|---|---|
| Fabrication | Rapid (seconds) | Slow (minutes) |
| Scrap | Reusable | High percentage waste |
| Curing Agents | None | Required |
| Machinery | Conventional | Special vulcanizing |
| | thermoplastic | equipment |
| | equipment | |
| Additives | Minimal or none | Numerous processing |
| | | aids |
| Remold parts | Yes | Impossible |
| Heat sealing | Yes | No |

The TPVs of the present invention are now commercially available from Thermoplastic Rubber Systems Inc. of Shirley, Mass. under the “Nex” series of trademarks. The Nex™ Series of TPE products is available in a hardness range from Shore 40A to Shore 50D. It is available in natural (colorable), black or any specific custom color that best fits the application. Specific trademarks in the series include; NexPrene® rubber; NexFlex™ rubber; NexLink™ rubber; and NexTrile™ rubber. Product Codes consist of four digits. The first digit identifies the type of elastomer; the second digit identifies the general use of the product; the third and fourth digits represent hardness values on the Shore Scales—A or D. Examples include the following:

First Digit—Type of elastomer:

1—NexPrene: EPDM/PP, fully vulcanized

2—NexFlex: SEBS or SEEPS/PP

3—NexLink: EPDM/SEBS/Polyacrylate/Nitrile alloys in a PP matrix

4—NexTrile: Nitrile/PP, fully vulcanized

Second Digit—Type of Use:

0—General Purpose

1—F.D.A/Food contact

2—Medical

3—NSF

4—FR/(UL)

5—Building Construction(AAMA)

Third & Fourth Digits—Hardness:

Shore 3 to 90—A scale

Shore 40D to 50D

Color Codes:

N—Natural

B—Black

Custom Color—Red, Blue, Yellow, Green, Brown, etc . . .

Special Property Codes:

U.V. resistance—UV

Automotive U.V. resistance—AUV

High Flow/Molding—HFM

Oil Resistance—OR

Over Molding/2 k—OM

Low C.O.F.—LCOF

Electrostatic dissipative—ESD

Conductive—CD

Fungus resistance—FUR

EMI shielding—EMI

Permanent Anti-Static—PAS

Glass Fiber—GF

Partially Vulcanized—PV

Non-Halogenated—NH

EXAMPLE—“NexPrene 1264A-Red(01)-HFM” means—EPDM based rubber, Medical Application, Shore 64A, Custom Red color, High Flow Molding grade.

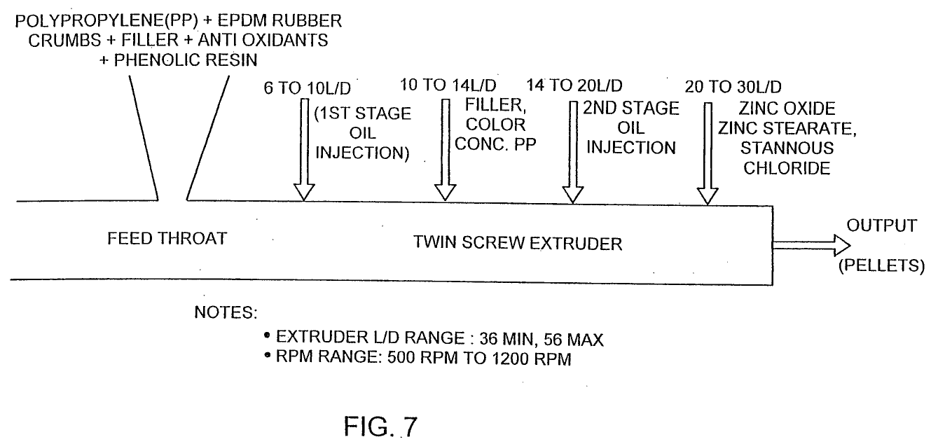

The present invention will be further illustrated with reference to the following examples which aid in the understanding of the present invention, but which are not to be construed as limitations thereof. All percentages reported herein, unless otherwise specified, are percent by weight. All temperatures are expressed in degrees Celsius. The preferred processing apparatus is illustrated in FIG. 7. Processing is conducted at a temperature range of 390° F. to 415° F., i.e., 198.9° C. to 212.8° C.

In Table 5 (below), the following list of components is employed in each of the designated Nexprene formulations:

A: EPDM Rubber

B: Polypropylene, Homopolymer

C: Filler

D: SBC

E: White Oil

F: Phenolic Resin

G: Anti Oxidant

H: Process aid (wax)

I: Zinc Oxide

J: Zinc Stereate

K: Stannous Chloride

TABLE 5
Nexprene Formula Ratios

| Component | A | B | C | D | E | F | G | H | I | J | K |
|---|---|---|---|---|---|---|---|---|---|---|---|
| 1040A | 25 | 10 | 4.5 | 17 | 41 | 0.75 | 0.2 | 1.75 | 0.7 | 0.2 | 0.2 |
| 1045A | 28 | 11 | 4.8 | 17 | 38 | 0.75 | 0.2 | 1.75 | 0.7 | 0.2 | 0.2 |
| 1050A | 30 | 12 | 5 | 17 | 35 | 0.75 | 0.2 | 1.75 | 0.7 | 0.2 | 0.2 |
| 1055A | 55 | 12 | 10.5 | | 16 | 1.5 | 0.4 | 2.5 | 1.4 | 0.4 | 0.4 |
| 1058A | 56 | 12.5 | 10.75 | | 14.5 | 1.5 | 0.4 | 2.5 | 1.4 | 0.4 | 0.4 |
| 1060A | 57 | 13 | 11 | | 13 | 1.5 | 0.4 | 2.5 | 1.4 | 0.4 | 0.4 |
| 1064A | 59 | 14.5 | 11 | | 9 | 1.75 | 0.4 | 2.5 | 1.4 | 0.4 | 0.4 |
| 1067A | 57.5 | 15 | 11 | | 9 | 1.75 | 0.4 | 2.5 | 1.4 | 0.4 | 0.4 |
| 1070A | 56 | 16.2 | 11 | | 9 | 1.75 | 0.4 | 2.5 | 1.4 | 0.4 | 0.4 |
| 1075A | 55 | 19.1 | 11 | | 9 | 1.75 | 0.4 | 1.5 | 1.4 | 0.4 | 0.4 |
| 1080A | 51 | 23.1 | 11 | | 8 | 1.75 | 0.4 | 1.1 | 1.4 | 0.4 | 0.4 |
| 1084A | 48 | 27.6 | 11 | | 8 | 1.75 | 0.4 | 1.1 | 1.4 | 0.4 | 0.4 |
| 1087A | 45 | 31.5 | 10.5 | | 8 | 1.75 | 0.4 | 1.1 | 1.4 | 0.4 | 0.4 |
| 1040D | 38 | 44.5 | 8 | | 7 | 1.5 | 0.4 | 1 | 1.0 | 0.2 | 0.2 |
| 1050D | 22 | 62.6 | 6 | | 7 | 0.87 | 0.3 | 1 | 0.5 | 0.16 | 0.16 |

The present invention has been described in detail, including the preferred embodiments thereof. However, it will be appreciated that those skilled in the art, upon consideration of the present disclosure, may make modifications and/or improvements on this invention and still be within the scope and spirit of this invention as set forth in the following claims.

What is claimed is:

1. An elastoplastic composition comprising a blend of thermoplastic crystalline polyolefin resin and fully cured EPDM rubber in the form of small dispersed particles essentially of a size of about 50 microns number average or less, wherein the rubber is cured with a phenolic curative, and wherein the EPDM rubber has a Mooney Viscosity of at least 100 MU as measured on uncured, raw rubber.

2. The composition of claim 1, wherein the EPDM rubber has a Mooney Viscosity of at least 150 MU.

3. The composition of claim 1, wherein the EPDM rubber has a Mooney Viscosity of at least 200 MU.

4. The composition of claim 1, wherein the EPDM rubber has a Mooney Viscosity of at least 250 MU.

5. The composition of claim 1, wherein the EPDM rubber has a Mooney Viscosity of at least 300 MU.

6. The composition of claim 1, wherein the blend comprises from about 15-75 parts by weight polyolefin resin and about 85-25 parts by weight of cured EPDM rubber per 100 parts total weight of resin and rubber.

7. The composition of claim 6, wherein the blend comprises from about 25-75 parts by weight polyolefin resin and about 75-25 parts by weight of cured EPDM rubber per 100 parts total weight of resin and rubber.

8. The composition of claim 7, wherein the polyolefin resin comprises polypropylene.

9. The composition of claim 8, further comprising from about 30-250 parts by weight of extender oil per 100 parts by weight of rubber.

10. The composition of claim 9, further comprising from about 2-250 parts by weight carbon black per 100 parts by weight rubber.

11. The composition of claim 8, wherein the phenolic curative comprises non-halogenated dimethylol-p-(C5-C10 alkyl) phenol.

12. The composition of claim 11, wherein the phenolic curative further comprises an activator selected from the group consisting of metal halide and halogen-donating polymer.

13. The composition of claim 12, wherein the halogen-donating polymer is chlorosulfonated polyethylene.

14. The composition of claim 13, wherein the cure activator further comprises zinc oxide.

15. The composition of claim 8, wherein the phenolic curative comprises a brominated phenolic curing resin and a metal oxide cure activator.

16. The composition of claim 15, wherein the metal oxide comprises zinc oxide.

17. The composition of claim 7, wherein the polyolefin resin comprises polyethylene.

18. The composition of claim 8, wherein the EPDM rubber comprises a terpolymer of ethylene, propylene and ethylidene norbornene.

19. The composition of claim 8, wherein the rubber is cured to at least 95% of the theoretical full cure.

20. The composition of claim 19, wherein the rubber is cured to at least 97% of the theoretical full cure, and the rubber is of the size of about 5 microns number average or less.

21. The composition of claim 18, wherein the rubber is cured to at least 99% of the theoretical full cure.

22. The composition of claim 8, wherein the rubber is cured to at least 95% of the theoretical full cure.

23. The composition of claim 1, prepared by masticating the blend and phenolic curative, in an amount sufficient to cure the rubber, at curing temperature until the rubber is cured to at least 95% of the theoretical full cure.

24. The composition of claim 8, comprising a blend of about 30-70 parts by weight polypropylene, about 30-70 parts by weight EPDM rubber, and 5-300 parts by weight extender oil per 100 parts total weight of polypropylene and rubber, and 10-100 parts by weight particulate filler per 100 parts total weight of rubber and extender oil, and wherein the EPDM rubber has a Mooney Viscosity of at least 100 MU as measured on uncured, raw rubber.

25. The composition of claim 24, wherein the EPDM rubber has a Mooney Viscosity of at least 150 MU.

26. The composition of claim 24, wherein the EPDM rubber has a Mooney Viscosity of at least 200 MU.

27. The composition of claim 24, wherein the EPDM rubber has a Mooney Viscosity of at least 250 MU.

28. The composition of claim 24, wherein the EPDM rubber has a Mooney Viscosity of at least 300 MU.

29. The composition of claim 24, wherein the particulate filler comprises carbon black.

30. The composition of claim 24, wherein the particulate filler comprises non-black filler.

31. The composition of claim 30, wherein the filler comprises clay.

32. The composition of claim 31, further comprising a silane coupling agent.

33. The composition of claim 14, wherein the phenolic curing resin is dimethylol-p-octyl phenol.

34. An elastoplastic composition comprising a blend of thermoplastic crystalline polyolefin resin, in an amount sufficient to impart thermoplasticity to the composition, and cured EPDM rubber in the form of small dispersed particles essentially of a size of about 50 microns number average or below, in an amount sufficient to impart rubber-like elasticity to the composition, in which the rubber is cured with phenolic curative comprising phenolic curing resin and cure activator to at least 95% of the theoretical full cure, and wherein the EPDM rubber has a Mooney Viscosity of at least 100 MU as measured on uncured, raw rubber.

35. The composition of claim 34, wherein the EPDM rubber has a Mooney Viscosity of at least 150 MU.

36. The composition of claim 34, wherein the EPDM rubber has a Mooney Viscosity of at least 200 MU.

37. The composition of claim 34, wherein the EPDM rubber has a Mooney Viscosity of at least 250 MU.

38. The composition of claim 34, wherein the EPDM rubber has a Mooney Viscosity of at least 300 MU.

39. The composition of claim 34, wherein the rubber is cured to at least 97% of the theoretical full cure.

40. The composition of claim 39, comprising a blend of about 15-75 parts by weight polyolefin resin and about 85-25 parts by weight of cured EPDM rubber per 100 parts total weight of polyolefin resin and rubber.

41. The composition of claim 40, comprising a blend of about 25-75 parts by weight polyolefin resin and about 75-25 parts by weight of cured EPDM rubber per 100 parts total weight of polyolefin resin and rubber.

42. The composition of claim 41, wherein the polyolefin resin comprises polypropylene.

43. The composition of claim 42, wherein the rubber comprises a terpolymer of ethylene, propylene, and ethylidene norbornene.

44. The composition of claim 43, further comprising from about 30 to 250 parts by weight of extender oil per 100 parts by weight of rubber.

45. The composition of claim 43, wherein the rubber is cured with a brominated phenolic curing resin.

46. The composition of claim 43, wherein the rubber is cured with a brominated phenolic curing resin and zinc oxide cure activator.

35. The composition of claim 33 containing halogen-donating polymer.

36. The composition of claim 26 in which the phenolic curing resin is non-halogenated dimethylol-p-(C5-C10 alkyl) phenol.

37. The composition of claim 36 wherein the cure activator is selected from the group consisting of metal halide and halogen-donating polymer.

38. The composition of claim 37 in which the halogen-donating polymer is chlorosulfonated polyethylene.

39. The composition of claim 38 in which the cure activator system includes zinc oxide.

40. The composition of claim 30 comprising a blend of about 30 to 70 parts by weight polypropylene, about 30 to about 70 parts by weight of EPDM rubber, and 5-300 parts by weight extender oil per 100 parts total weight of polypropylene and rubber, and 10-100 parts by weight particulate filler per 100 parts total weight of rubber and extender oil.

41. The filled composition of claim 40 in which the particulate filler is carbon black.

42. The filled composition of claim 40 in which the particulate filler is a non-black filler.

43. The filled composition of claim 42 in which the filler is kaolin clay.

44. The filled composition of claim 43 containing silane coupling agent.

45. The composition of claim 30 in which the cured EPDM rubber is of the size of about 5 microns number average or below.

46. The composition of claim 40 in which the cured EPDM rubber is the size of about 5 microns number average or below.
